(19) United States
(12) Patent Application Publication
(10) Pub. No.: US 2022/0351220 A1
(43) Pub. Date: Nov. 3, 2022

(54) MACHINE LEARNING SYSTEM FOR PROTECTING SYSTEM RESOURCES DURING UNPLANNED EVENTS

(71) Applicant: Toshiba Global Commerce Solutions Holdings Corporation, Tokyo (JP)

(72) Inventors: Brad M. JOHNSON, Raleigh, NC (US); David Bernath, Durham, NC (US); Wacho Slaughter, Raleigh, NC (US)

(21) Appl. No.: 17/306,931

(22) Filed: May 3, 2021

(51) Int. Cl. G06Q 30/02; G06Q 30/06; G06N 20/00

(52) U.S. Cl. CPC G06Q 30/0202; G06Q 30/0201; G06Q 30/0633; G06N 20/00

(57) ABSTRACT

A method includes receiving, from a user, an unscheduled order to be fulfilled when a corresponding unplanned event is predicted to occur. The unscheduled order includes a plurality of items. The method also includes applying a machine learning model to an information feed to predict that the unplanned event will occur and, in response to determining that the unplanned event will occur, communicating the plurality of items to a store to purchase the plurality of items for the user.

### BACKGROUND

The present invention relates to machine learning systems, and more specifically, to a machine learning system that protects system resources during unplanned events (e.g., disasters).

### SUMMARY

According to an embodiment, a method includes receiving, from a user, an unscheduled order to be fulfilled when a corresponding unplanned event is predicted to occur. The unscheduled order includes a plurality of items. The method also includes applying a machine learning model to an information feed to predict that the unplanned event will occur and in response to determining that the unplanned event will occur, communicating the plurality of items to a store to purchase the plurality of items for the user. Other embodiments include an apparatus for performing this method.

According to another embodiment, a method includes receiving, from a user, an indication of a plurality of items to be purchased when a corresponding unplanned event is predicted to occur and communicating the plurality of items and the corresponding unplanned event to a server. The method also includes receiving, from the server, a message indicating that the unplanned event is predicted to occur and communicating, to the server, a confirmation to the message, wherein the plurality of items are communicated to a store in response to the confirmation.

### BRIEF DESCRIPTION OF THE DRAWINGS

FIG. 1 illustrates an example system.

FIG. 2 is a flowchart of an example method in the system of FIG. 1.

FIG. 3 is a flowchart of an example method in the system of FIG. 1.

FIG. 4 is a flowchart of an example method in the system of FIG. 1.

### DETAILED DESCRIPTION

When certain unplanned events (e.g., weather events, pandemics, economic crises) occur, the public may begin buying certain items in large quantities out of fear of running out of these items. For example, when major weather events happen, the public may buy large quantities of milk, bread, and water. As another example, when pandemics happen, the public may buy large quantities of toilet paper and disinfecting wipes. As technology has advanced, the public has relied more on stores' digital or e-commerce systems. When certain unplanned events occur, these systems become flooded with orders, which causes these systems to crash. As a result, the public is unable to acquire necessary items, which jeopardizes their health and safety during certain events.

This disclosure contemplates a system that protects the system resources (e.g., processor and memory resources) of the stores' digital or e-commerce systems by applying a machine learning model to predict when certain events will occur. When an event is predicted to occur, the system communicates orders for particular items so that these orders can be received and fulfilled by the stores well in advance of the event actually occurring. In this manner, when the event occurs, the stores' digital or e-commerce systems encounter less load, which allows the stores' systems to continue operating and the public to continue having access to needed items, in particular embodiments.

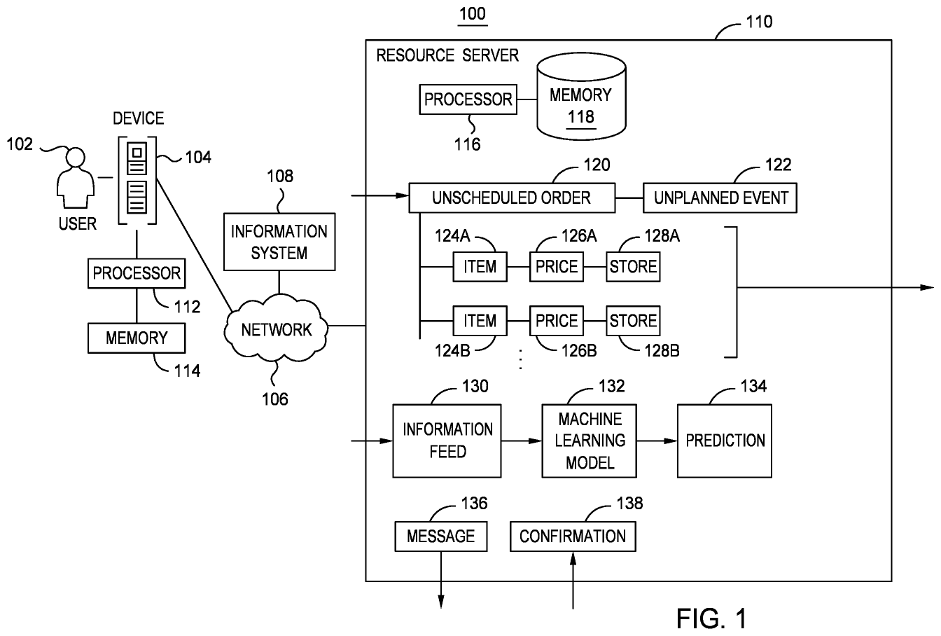

FIG. 1 illustrates and example system 100. As seen in FIG. 1, the system 100 includes one or more devices 104, a network 106, one or more information systems 108, and a resource server 110. Generally, the resource server 110 protects a store's digital or ecommerce systems by applying a machine learning model to predict when certain events will occur. When the resource server 110 predicts that certain events will occur, the resource server 110 communicates to the store one or more unscheduled orders that correspond with the predicted event. The store may then fulfill the order before the event actually occurs. In this manner, when the event occurs, the store's digital or ecommerce systems experience reduced load, which allows the store's systems to continue operating and allows the public to continue having access to needed items, in particular embodiments.

A user 102 uses the one or more devices 104 to communicate with other components of the system 100. The user 102 may use a device 104 to communicate to the resource server 110 one or more items that the user 102 would buy when a particular event occurs. For example, the user 102 may use the device 104 to indicate that the user 102 would buy bread and milk when a snowstorm or financial crisis occurs. As another example, the user 102 may use the device 104 to indicate that the user 102 would buy plywood and sandbags if a hurricane occurs. As yet another example, the user 102 may use the device 104 to indicate that the user 102 would buy toilet paper and disinfecting wipes if a pandemic occurs.

The device 104 includes any suitable device for communicating with components of the system 100 over the network 106. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user 102. The device 104 may include a hardware processor 112, memory 114, or circuitry configured to perform any of the functions or actions of the device 104 described herein. For example, a software application designed using software code may be stored in the memory and executed by the processor to perform the functions of the device 104.

The processor 112 is any electronic circuitry, including, but not limited to microprocessors, application specific integrated circuits (ASIC), application specific instruction set processor (ASIP), and/or state machines, that communicatively couples to memory 114 and controls the operation of the device 104. The processor 112 may be 8-bit, 16-bit, 32-bit, 64-bit or of any other suitable architecture. The processor 112 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 112 may include other hardware that operates software to control and process information. The processor 112 executes software stored on memory to perform any of the functions described herein. The processor 112 controls the operation and administration of the device 104 by processing information (e.g., information received from the resource server 110, network 106, and memory 114). The processor 112 may be a programmable logic device, a microcontroller, a microprocessor, any suitable processing device, or any suitable combination of the preceding. The processor 112 is not limited to a single processing device and may encompass multiple processing devices.

The memory 114 may store, either permanently or temporarily, data, operational software, or other information for the processor 112. The memory 114 may include any one or a combination of volatile or non-volatile local or remote devices suitable for storing information. For example, the memory 114 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 114, a disk, a CD, or a flash drive. In particular embodiments, the software may include an application executable by the processor 112 to perform one or more of the functions described herein.

The network 106 is any suitable network operable to facilitate communication between the components of the system 100. The network 106 may include any interconnecting system capable of transmitting audio, video, signals, data, messages, or any combination of the preceding. The network 106 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

The one or more information systems 108 provide information that the resource server 110 uses to make predictions. For example, an information system 108 may be a weather forecasting system that provides weather forecasts to the resource server 110. The resource server 110 may analyze these weather forecasts to predict whether certain weather events will occur. As another example, an information system 108 may be a financial system that provides information about financial accounts. The resource server 110 may analyze the financial information to predict whether a financial crisis is about to occur. As yet another example, an information system 108 may be a disease tracking system that provides information concerning the spread of a disease (e.g., a disease infection map). The resource server 110 may analyze the spread of the disease to predict whether a pandemic will occur. When a weather event, a financial crisis, or a pandemic actually occurs the one or more information systems 108 may update their information to account for the occurrence of the event. The resource server 110 may update its predictions based on the updated information.

The resource server 110 predicts when certain events will occur, and in response, communicates unscheduled orders to stores. In this manner, the resource server 110 reduces the load on the stores' digital or ecommerce systems during particular events that typically cause increased load on those systems. As a result, the resource server 110 helps the stores' digital or ecommerce systems to continue operating, which allows the public to continue having access to needed items, in particular embodiments. As seen in FIG. 1, the resource server 110 includes a processor 116 and a memory 118, which are configured to perform any of the actions or functions of the resource server 110 described herein.

The processor 116 is any electronic circuitry, including, but not limited to microprocessors, application specific integrated circuits (ASIC), application specific instruction set processor (ASIP), and/or state machines, that communicatively couples to memory 118 and controls the operation of the resource server 110. The processor 116 may be 8-bit, 16-bit, 32-bit, 64-bit or of any other suitable architecture. The processor 116 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 116 may include other hardware that operates software to control and process information. The processor 116 executes software stored on memory to perform any of the functions described herein. The processor 116 controls the operation and administration of the resource server 110 by processing information (e.g., information received from the devices 104, network 106, and memory 118). The processor 116 may be a programmable logic device, a microcontroller, a microprocessor, any suitable processing device, or any suitable combination of the preceding. The processor 116 is not limited to a single processing device and may encompass multiple processing devices.

The memory 118 may store, either permanently or temporarily, data, operational software, or other information for the processor 116. The memory 118 may include any one or a combination of volatile or non-volatile local or remote devices suitable for storing information. For example, the memory 118 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 118, a disk, a CD, or a flash drive. In particular embodiments, the software may include an application executable by the processor 116 to perform one or more of the functions described herein.

The resource server 110 receives an unscheduled order 120 and a corresponding unplanned event 122 from the device 104. The user 102 may have set the unscheduled order 120 and the unplanned event 122 using the device 104. The unscheduled order 120 includes a number of items 124. The items 124 in the unscheduled order 120 may be items that the user 102 would purchase if the unplanned event 122 corresponding to the unscheduled order 120 occurs. In the example of FIG. 1 the unscheduled order 120 includes an item 124A and an item 124B.

The unplanned event 122 may be any event for which the user 102 may prepare by purchasing the items 124 in the unscheduled order 120. For example, the unplanned event 122 may be a snowstorm, and the user 102 may specify that if the snowstorm were predicted to occur, the user 102 would purchase milk and bread. As a result, the unscheduled order 120 for the snowstorm would include the items 124 milk and bread. As another example, if the unplanned event 122 is a hurricane, the user 102 may indicate that the user 102 would purchase plywood and sandbags to prepare for the hurricane. As a result, the unscheduled order 120 corresponding to the hurricane would include the items 124 plywood and sandbags. As yet another example, the unplanned event 122 may be a pandemic, and the user 102 may indicate that the user 102 would purchase toilet paper and disinfecting wipes to prepare for the pandemic. As a result, the unscheduled order 120 corresponding to the pandemic would include the items 124 toilet paper and disinfecting wipes. The resource server 110 stores the unscheduled order 120 and the corresponding unplanned event 122 (e.g., in a database). The resource server 110 retrieves the unscheduled order 120 and the unplanned event 122 when the resource server 110 predicts that the unplanned event 122 will occur.

In particular embodiments, the unscheduled order 120 includes desired prices 126 for the items 124 in the unscheduled order 120. The user 102 may indicate the desired prices 126 for particular items 124 in the unscheduled order 120. In the example of FIG. 1, the item 124A has a desired price 126A, and the item 124B has a desired price 126B. When the resource server 110 predicts that the unplanned event 122 corresponding to the unscheduled order 120 will occur, the resource server 110 may perform an additional check on the prices of the items 124 before communicating the unscheduled order 120 to the store. For example, the resource server 110 may determine whether the prices that the store sets on the items 124 falls below the desired prices 126 indicated in the unscheduled order 120. If the store's prices are below the desired prices 126, then the resource server 110 communicates the unscheduled order 120 to purchase the items 124. If the stores prices for certain items 124 exceed the desired prices 126 indicated in the unscheduled order 120, then the resource server 110 may not communicate the unscheduled order 120 for those items 124. For example, if a store's price for the item 124A exceeds the desired price 126A but the store's price for the item 124B is below the desired price 126B, then the resource server 110 may communicate the unscheduled order 120 for the item 124B but not for the item 124A. As a result, the resource server 110 may order certain items 124 based on the desired price 126, while leaving other items 124 unordered.

In some embodiments, the unscheduled order 120 indicates desired stores 128 for particular items 124. The user 102 may indicate a desired or preferred store 128 for each item 124 in the unscheduled order 120. When the resource server 110 predicts that the unplanned event 122 corresponding to the unscheduled order 120 will occur, the resource server 110 may communicate the unscheduled order 120 to the desired or preferred stores 128 indicated in the unscheduled order 120. In the example of FIG. 1, the item 124A has a desired or preferred store 128B and the item 1246 has a desired or preferred store 1286. When the resource server 110 predicts that the unplanned event 122 will occur, the resource server 110 may communicate the unscheduled order 120 for the item 124A to the store 128A and the unscheduled order 120 for the item 124B to the store 128B. In this manner, the resource server 110 may communicate unscheduled orders 120 to the user's 102 desired or preferred stores 128. When the store receives the unscheduled order 120, the store may complete the purchase and deliver the items 124 to the user 102.

The resource server 110 receives an information feed 130 from the one or more information systems 108. The information feed 130 may include any information that the resource server 110 uses to predict whether certain events will occur. For example, the information feed 130 may include a weather forecast that the resource server 110 uses to predict whether certain weather events will occur. As another example, the information feed 130 may include information about financial accounts, which the resource server 110 may use to predict whether a financial crisis is about to occur. As yet another example, the information feed 130 may include disease tracking information, which the resource server 110 uses to predict whether a pandemic will occur.

The resource server 110 applies a machine learning model 132 to the information feed 130 to generate a prediction 134. The machine learning model 132 may be trained to analyze any type of information in the information feed 130 to make any type of prediction 134. For example, the machine learning model 132 may analyze weather forecasts to predict whether a particular weather event will occur. As another example, the machine learning model 132 may analyze financial information to predict whether a financial crisis will occur. As yet another example, the machine learning model 132 may analyze disease tracking information (e.g., a disease infection map or dashboard) to predict whether a pandemic will occur. The machine learning model 132 may analyze the information feed 130 to predict a likelihood that the unplanned event 122 will occur. When the predicted likelihood exceeds a threshold probability, the machine learning 132 may predict that the unplanned event 122 will occur.

When the machine learning model 132 predicts that a particular event will occur, the resource server 110 determines whether the predicted event is an unplanned event 122 corresponding to an unscheduled order 120. For example, if the machine learning model 132 predicts that a snowstorm will occur, the resource server 110 may retrieve the unscheduled order 120 corresponding to a snowstorm. As another example, if the machine learning model 132 predicts that a financial crisis will occur, the resource server 110 retrieves the unscheduled order 120 for a financial crisis. As yet another example, if the machine learning model 132 predicts that a pandemic will occur, the resource server 110 retrieves the unscheduled order 120 for a pandemic. The resource server 110 then communicates the retrieved unscheduled order 120 to a store to complete the order for the user 102.

In certain embodiments, the resource server 110 communicates a message 136 to the device 104 before communicating the retrieved unscheduled order 120. The message 136 may notify the user 102 that the resource server 110 has predicted that a particular unplanned event 122 will occur. The message 136 may also ask the user 102 to confirm whether the user 102 still wishes to purchase the items 124 in the retrieved unscheduled order 120. In embodiments where the resource server 110 determines that a preferred store's price for an item 124 exceeds the user's 102 desired price 126 for the item 124, the message 136 may request the user 102 to confirm whether the user 102 wishes to purchase the item 124 at the store's price. The resource server 110 may receive a confirmation 138 from the device 104 if the user 102 confirms the purchase. For example, the confirmation 138 may confirm that the user 102 still wishes to purchase items 124 in response to the unplanned event 122 being predicted to occur. As another example, the confirmation 138 may confirm that the user wishes to purchase an item 124 at a price that exceeds the desired price 126 for the item 124. The resource server 110 communicates the unscheduled order 120 to a store in response to receiving the confirmation 138. If the resource server 110 does not receive the confirmation 138, the resource server 110 may not communicate the unscheduled order 120 to the store.

In particular embodiments, the resource server 110 performs additional checks before communicating the unscheduled order 120 to the store. For example, the resource server 110 may check whether the store has an item 124 in the unscheduled order 120 before communicating the unscheduled order 120 to the store. As another example, the resource server 110 may check whether the store is operating (e.g., whether the store has electric power) before communicating the unscheduled order 120 to the store. If the store does not have the item 124 or if the store is not operating, the resource server 110 may communicate the unscheduled order to another store that is operating or that has the item. The unscheduled order 120 may indicate any number of preferred stores 128 for an item 124. If a first preferred store 128 is not operating or does not have the item 124, the resource server 110 selects the next preferred store 128 as a candidate. The resource server 110 proceeds through the preferred stores 128 until the resource server 110 finds a store that can provide the item 124.

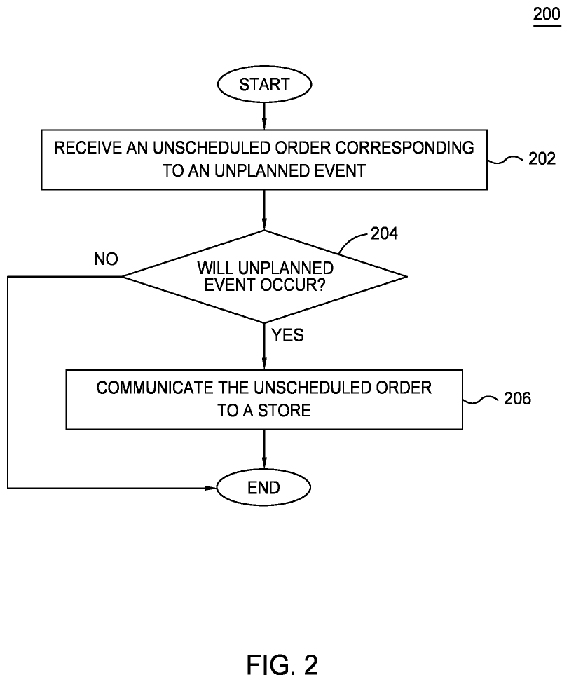

FIG. 2 is a flowchart of an example method 200 in the system 100 of FIG. 1. The resource server 110 performs the method 200. In particular embodiments, by performing the method 200, the resource server 110 reduces the load on a store's digital or ecommerce systems during an unplanned event by communicating unscheduled orders to the store before the event occurs.

In block 202, the resource server 110 receives, from a user 102, an unscheduled order 120 corresponding to an unplanned event 122. Before an unplanned event occurs (or is predicted to occur in the future), the user 102 may have generated the unscheduled order 120 and specified the unplanned event 122 to indicate that the user 102 desires for the unscheduled order 120 to be made when the resource server 110 predicts that the unplanned event 122 will occur. The unscheduled order 120 may include one or more items 124 that the user 102 desires to purchase when the resource server 110 predicts that the unplanned event 122 with occur. For example, the user 102 may specify that if the resource server 110 predicts that a snowstorm will occur, then the user 102 wants milk and bread to be purchased. As another example, the user 102 may specify that if the resource server 110 predicts that a hurricane will occur, then plywood and sandbags should be purchased. As yet another example, the user 102 may specify that, if the resource server 110 predicts that a pandemic will occur, then toilet paper and disinfecting wipes should be purchased. The resource server 110 may store the unscheduled order 120 and the unplanned event 122 for subsequent use, e.g., in a database.

In block 204, the resource server 110 predicts whether an unplanned event will occur. The resource server 110 may apply a machine learning model 132 to an information feed 130 to predict whether the unplanned event 122 will occur. The machine learning model 132 may analyze the information feed 130 to predict a likelihood that the unplanned event 122 will occur. When the predicted likelihood exceeds a threshold probability, the machine learning 132 may predict that the unplanned event 122 will occur. The information feed 130 may include any suitable information that the machine learning model 132 may analyze to make the prediction 134. For example, the information feed 130 may be a weather forecast that the machine learning model 132 uses to predict whether certain weather events will occur. As another example, the information feed 130 may be information about financial accounts that the machine learning model 132 may use to predict whether a financial crisis will occur. As yet another example, the information feed 130 may be disease tracking information that the machine learning model 132 may use to predict whether a pandemic will occur.

If the resource server 110 predicts that the unplanned event 122 will not occur, then the resource server 110 concludes the method 200. If the resource server 110 predicts that the unplanned event 122 will occur, then the resource server 110 communicates the unscheduled order 120 to a store in block 206. By communicating the unscheduled order 120 to the store, the resource server 110 indicates to the store that the items 124 in the unscheduled order 120 should be purchased and delivered to the user 102. In one embodiment, the resource server 110 communicates the unscheduled order 120 to the store automatically without input from the user who generated the order at block 202. However, in another embodiment, the resource server 110 may request confirmation from the user before submitting the order to the store (e.g., a SMS message or email confirmation to the user). In this manner, the resource server 110 executes the unscheduled order 120 before the unplanned event 122 actually occurs. As a result, the store's systems experience reduced load when the unplanned event 122 actually occurs, which allows the store to continue operations and to provide needed items to the public.

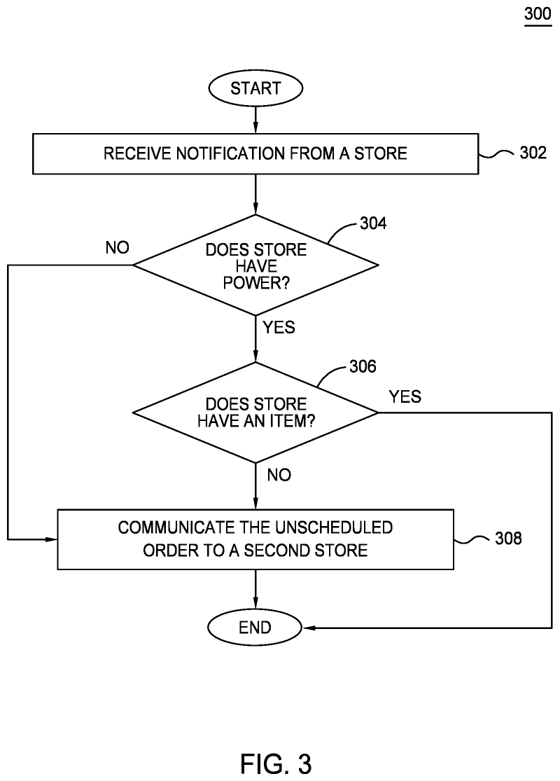

FIG. 3 is a flowchart of an example method 300 in the system 100 of FIG. 1. The resource server 110 performs the method 300. In particular embodiments, by performing the method 300, the resource server 110 performs additional checks that ensure that the unscheduled order 120 can be fulfilled.

In block 302, the resource server 110 receives a notification from a store. The notification may include information about the store or items within the store. The store may have communicated the notification in response to the resource server 110 communicating an unscheduled order 120 to the store for fulfillment. The resource server 110 may have communicated the unscheduled order 120 to the store in response to predicting that an unplanned event 122 corresponding to the unscheduled order 120 will occur.

In block 304, the resource server 110 determines whether the store has power based on the notification. For example, the notification may indicate that the store does not have electric power and cannot fulfill orders. If the notification indicates that the store has electric power, the resource server 110 continues with the method 300. If the notification indicates that the store does not have power, then the resource server 110 proceeds to block 308 to communicate the unscheduled order 120 to a second store that may have power. As a result, the second store may fulfill the unscheduled order 120.

In block 306, the resource server 110 determines whether the store has an item 124 indicated in the unscheduled order 120. For example, the notification may indicate the items 124 that the store does not have. If the notification indicates that the store does not have a particular item 124, then the resource server 110 proceeds to block 308 to communicate the unscheduled order 120 to the second store. In certain embodiments, the resource server 110 communicates to the second store only the items 124 that the first store did not have. If the notification indicates that the store has the items 124 in the unscheduled order 120, then the resource server 110 concludes the method 300 and the store fulfills the unscheduled order 120.

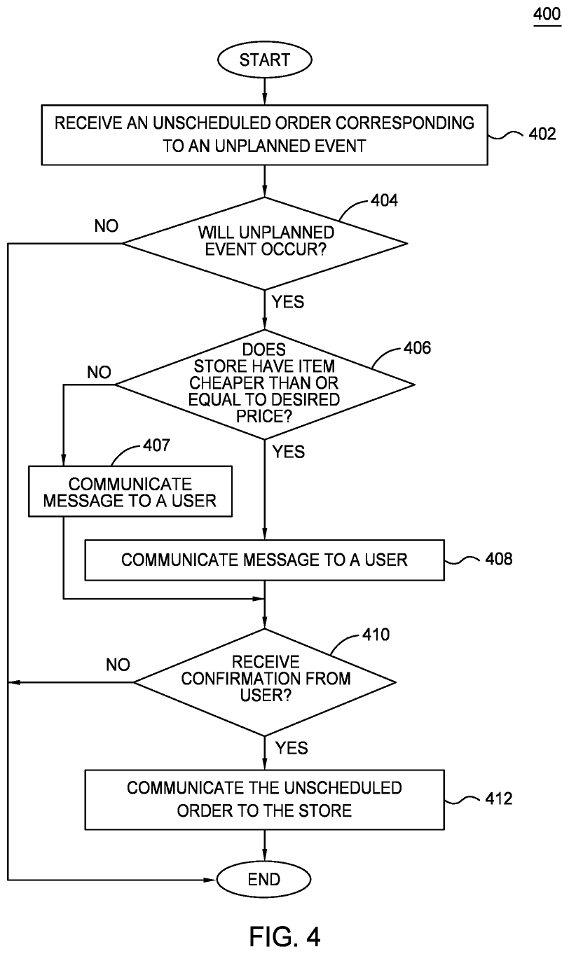

FIG. 4 is a flowchart of an example method 400 in the system 100 of FIG. 1. The resource server 110 performs the method 400. In particular embodiments, by performing the method 400, the resource server 110 performs additional checks that follow the preferences and desires set by a user 102.

In block 402, the resource server 110 receives an unscheduled order 120 corresponding to an unplanned event 122. The unscheduled order 120 includes items 124 that the user 102 desires to purchase when the resource server 110 predicts that the unplanned event 122 will occur. The unscheduled order 120 also indicates desired prices 126 for the items 124 and preferred stores 128 for the items 124. In block 404, the resource server 110 predicts whether the unplanned event 122 will occur. The resource server 110 applies a machine learning model 132 to an information feed 130 to predict whether the unplanned event 122 will occur. If the resource server 110 determines that the unplanned event 122 will not occur, then the resource server 110 concludes the method 400.

If the resource server 110 predicts that the unplanned event 122 will occur, the resource server 110 determines whether a store sets a price for an item 124 that is lower than or equal to the desired price 126 corresponding to that item 124 in the unscheduled order 120 in block 406. In other words, the resource server 110 determines whether the store's price for a desired item 124 is lower than a desired price 126 for that item 124 set by the user 102. If the store's price for the desired item 124 is more expensive than the desired price 126 set by the user 102, then the resource server 110 communicates a message 136 to the user 102 in block 407. The message 136 may notify the user that the unplanned event 122 has been predicted to occur but that the store's price for the item 124 exceeds the desired price 126 set by the user 102. The message 136 may request the user 102 to confirm whether the user 102 still wants to purchase the item 124 from the store even though the store's price exceeds the user's 102 desired price 126.

If the store's price is lower than the desired price 126, then the resource server 110 communicates a message 136 to the user 102 in block 408. The message 136 may indicate that the resource server 110 has predicted that the unplanned event 122 will occur. Additionally, the message 136 may request that the user confirm that the user 102 still desires to purchase the items 124 identified in the unscheduled order 120.

In block 410, the resource server 110 determines whether a confirmation 138 to the message 136 was received from the user 102. The confirmation 138 may be to the message 136 communicated in block 407 or the message 136 communicated in block 408. If the confirmation 138 was not received, the resource server 110 concludes the method 400 and does not purchase an item 124. If the confirmation 138 was received, the resource server 110 communicates the unscheduled order 120 to the store in block 412. The store may then fulfill the unscheduled order 120 by purchasing the items 124 and delivering the items 124 to the user 102.

In summary, a resource server 110 protects the system resources (e.g., processor and memory resources) of a store's digital or e-commerce systems by applying a machine learning model 132 to predict when certain events will occur. When an event is predicted to occur, the resource server 110 communicates unscheduled orders 120 for particular items 124 to the store so that the store can fulfill the orders 120 well in advance of the event actually occurring. In this manner, when the event occurs, the store's digital or e-commerce systems encounter less load, which allows the store's systems to continue operating and the public to continue having access to needed items, in particular embodiments.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the resource server 110) or related data available in the cloud. For example, the resource server 110 could execute on a computing system in the cloud. In such a case, the resource server 110 could apply the machine learning model 132 to an information feed 130 received from information systems 108 in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A method comprising:
receiving, from a user, an unscheduled order to be fulfilled when a corresponding unplanned event is predicted to occur, the unscheduled order comprising a plurality of items;
applying a machine learning model to an information feed to predict that the unplanned event will occur; and
in response to determining that the unplanned event will occur, communicating the plurality of items to a store to purchase the plurality of items for the user.

2. The method of claim 1, wherein the unplanned event is a weather event and wherein the information feed is a weather forecast indicating a probability that the weather event will occur.

3. The method of claim 1, wherein the information feed is a financial account of the user and wherein the unplanned event comprises a balance of the financial account falling below a threshold.

4. The method of claim 1, wherein the information feed is a disease infection map indicating a spread of a disease.

5. The method of claim 1, wherein the user indicates the store in the unscheduled order.

6. The method of claim 1, wherein the unscheduled order indicates a plurality of desired prices for the plurality of items and wherein communicating the plurality of items to the store is further in response to determining that the plurality of desired prices exceed prices that the store set for the plurality of items.

7. The method of claim 1, wherein communicating the plurality of items to the store is further in response to determining that a second store lost electric power.

8. The method of claim 1, further comprising communicating a message to the user in response to predicting that the unplanned event will occur, wherein communicating the plurality of items to the store is further in response to receiving, from the user, a confirmation in response to the message.

9. The method of claim 1, wherein communicating the plurality of items to the store is further in response to determining that a second store does not have the plurality of items.

10. An apparatus comprising:
a memory; and
a hardware processor communicatively coupled to the memory, the hardware processor configured to:
receiving, from a user, an unscheduled order to be fulfilled when a corresponding unplanned event is predicted to occur, the unscheduled order comprising a plurality of items;
applying a machine learning model to an information feed to predict that the unplanned event will occur; and
in response to determining that the unplanned event will occur, communicate the plurality of items to a store to purchase the plurality of items for the user.

11. The apparatus of claim 10, wherein the unplanned event is a weather event and wherein the information feed is a weather forecast indicating a probability that the weather event will occur.

12. The apparatus of claim 10, wherein the information feed is a financial account of the user and wherein the unplanned event comprises a balance of the financial account falling below a threshold.

13. The apparatus of claim 10, wherein the information feed is a disease infection map indicating a spread of a disease.

14. The apparatus of claim 10, wherein the user indicates the store in the unscheduled order.

15. The apparatus of claim 10, wherein the unscheduled order indicates a plurality of desired prices for the plurality of items and wherein communicating the plurality of items to the store is further in response to determining that the plurality of desired prices exceed prices that the store set for the plurality of items.

16. The apparatus of claim 10, wherein communicating the plurality of items to the store is further in response to determining that a second store lost electric power.

17. The apparatus of claim 10, the hardware processor further configured to communicate a message to the user in response to predicting that the unplanned event will occur, wherein communicating the plurality of items to the store is further in response to receiving, from the user, a confirmation in response to the message.

18. The apparatus of claim 10, wherein communicating the plurality of items to the store is further in response to determining that a second store does not have the plurality of items.

19. A method comprising:
receiving, from a user, an indication of a plurality of items to be purchased when a corresponding unplanned event is predicted to occur;
communicating the plurality of items and the corresponding unplanned event to a server;
receiving, from the server, a message indicating that the unplanned event is predicted to occur; and
communicating, to the server, a confirmation to the message, wherein the plurality of items are communicated to a store in response to the confirmation.

20. The method of claim 19, further comprising:
receiving, from the user, the store; and
communicating the store to the server.
